(19) United States
(12) Patent Application Publication
(10) Pub. No.: US 2008/0007403 A1
(43) Pub. Date: Jan. 10, 2008

(54) Home security system intergrating local wireless network and external communication networks

(75) Inventors: Yen-Hung Lai, Tapei (TW); Cheng-Huan Chung, Tapei (TW)

Correspondence Address: BIRCH STEWART KOLASCH & BIRCH, PO BOX 747, FALLS CHURCH, VA, 22040-0747, US

(73) Assignee: COMPAL COMMUNICATIONS, INC., Tapei (TW)

(21) Appl. No.: 11/819,163

(22) Filed: Jun. 25, 2007

(30) Foreign Application Priority Data
Jun. 23, 2006 (TW) 095125984

(51) Int. Cl. G08B 13/00

(52) U.S. Cl. 340/541

(57) ABSTRACT

The invention is to provide a home security system capable of linking to an external communication network. N terminals are capable of linking to the external communication network. The home security system includes M sensing units and a coordinator. Each of the M sensing units includes a sensor and a transmitting module. The coordinator includes a receiving module, a storage device, a communication module, and a processor. The receiving module receives a trigger signal from one of the M transmitting modules. The processor receives the trigger signal received from the receiving module and transmitted by the transmitting module. The processor accesses a contact rule corresponding to the transmitting module, and transmits, according to the accessed contact rule, information to the terminal corresponding to the accessed contact rule through the communication module and over the external communication network.

### BACKGROUND OF THE INVENTION

1. Field of the invention

The invention relates to a home security system capable of linking to an external communication network and, more particularly, relates to a home security system with Zigbee wireless transmission.

2. Description of the prior art

A digital home is based on a home network which connects to electronic products, such as a personal computer, an information appliance, a digital audio/video appliance, a digital TV, and so on, so as to form a connected home structure. The home network utilizes a specific home gateway to integrate external networks to achieve E-life prospect, such as home power management, home security, home care, remote repair of home appliance, digital interactive TV, and so on.

In order to get rid of wires at home, many companies invest in development of wireless communication technologies. The most frequently discussed local wireless communication technologies so far are Wi-Fi, UWB, Bluetooth, and Zigbee.

Zigbee is a wireless communication technique with low power, short range, and low transmission speed which mainly follows the IEEE 802.15.4 standard. Zigbee shares 2.4 MHz frequency range with Bluetooth, but the transmission speed of Zigbee is slower than that of Bluetooth (the transmission speed of Bluetooth is about 1Mbps).

However, Zigbee has an advantage in power-saving. In general, a battery in a Zigbee system can continuously supply the system to operate in 6 to 24 months, so the Zigbee system meets the demand of operating for a long time. Additionally, Zigbee has advantages in simple structure and low cost.

Therefore, one scope of the invention is to provide a home security system capable of linking to an external communication network. A sensing unit of the home security system transmits a trigger signal in Zigbee wireless communication technique. A coordinator of the home security system can be preset with at least one contact rule. According to the contact rule corresponding to the sensing unit generating the trigger signal, the coordinator transmits information to the terminals corresponding to the contact rule via the external communication network.

### SUMMARY OF THE INVENTION

One scope of the invention is to provide a home security system capable of linking to an external communication network. N terminals are capable of linking to the external communication network. N is a natural number.

According to a preferred embodiment of the invention, a home security system capable of linking to an external communication network comprises M sensing units and a coordinator. M is a natural number.

In this embodiment, each of the M sensing units comprises a sensor and a transmitting module. The sensor is used for generating a sensed signal associated with the neighboring area thereof and judging whether the received sensed signal meets a criterion. If YES, the sensor generates a trigger signal. The transmitting module is electrically connected to the sensor. The transmitting module is used for transmitting the trigger signal in a wireless local communication protocol.

In this embodiment, the coordinator comprises a receiving module, a storage device, a communication module, and a processor. The receiving module is used for receiving the trigger signal transmitted by one of the M transmitting modules. The storage device is used for storing I contact rules. Each of the I contact rules corresponds to one of the M transmitting modules and at least one of the N terminals. I is a natural number. The communication module is capable of linking to the external communication network. The processor is electrically connected to the receiving module, the storage device, and the communication module respectively. The processor is used for receiving the trigger signal received from the receiving module and transmitted by the transmitting module. The processor accesses the contact rule corresponding to the transmitting module from the storage device, and it transmits, according to the accessed contact rule, information to the terminals corresponding to the accessed contact rule through the communication module and the external communication network.

The advantage and spirit of the invention may be understood by the following recitations together with the appended drawings.

### BRIEF DESCRIPTION OF THE APPENDED DRAWINGS

FIG. 1 is a schematic diagram illustrating a home security system capable of linking to an external network according to a preferred embodiment of the invention.

FIG. 2 is a functional block diagram illustrating the essential components of the home security system in FIG. 1.

### DETAILED DESCRIPTION OF THE INVENTION

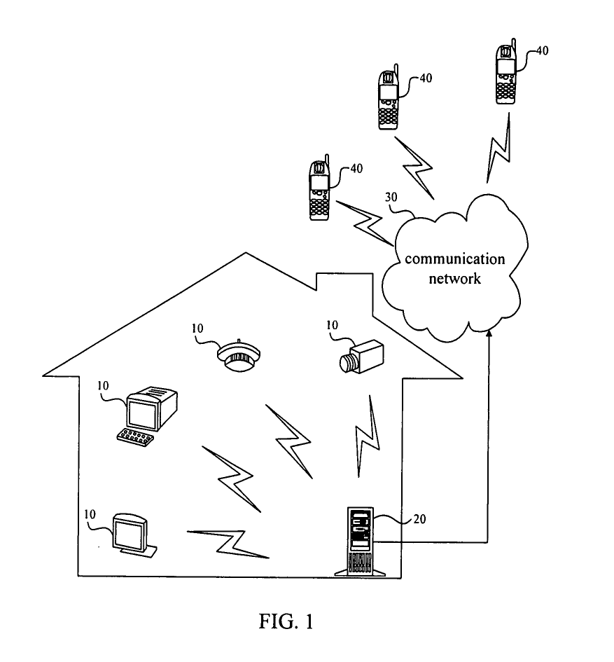

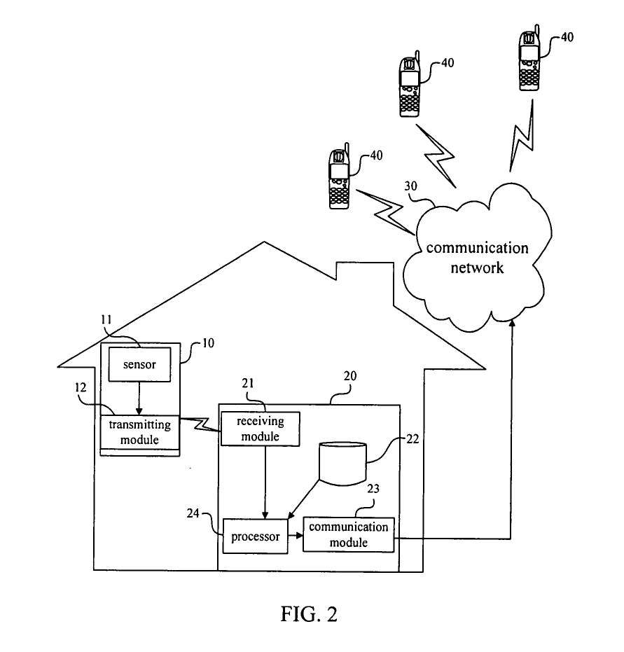

Please refer to FIG. 1 and FIG. 2, FIG. 1 is a schematic diagram illustrating a home security system capable of linking to an external network according to a preferred embodiment of the invention. FIG. 2 is a functional block diagram illustrating the essential components of the home security system in FIG. 1. FIG. 2 shows how the information is transmitted between the components, and only one sensing unit is illustrated in FIG. 2 for representation.

As shown in FIG. 1 and FIG. 2, the home security system can connect to an external communication network 30. N terminals 40 can connect to the external communication network 30. N is a natural number. FIG. 1 and FIG. 2 merely depict three cell phones to be the terminals 40 for illustration.

The external communication network can be a radio telecommunication system network, a wireless wide area network, or an internet.

The home security system comprises M sensing units 10 and a coordinator 20. M is a natural number. FIG. 1 and FIG. 2 only depict one digital TV, one personal computer, one smoke detector, and one monitor to be the sensing units 10 for illustration.

Each of the M sensing units 10 comprises a sensor 11 and a transmitting module 12.

The sensor 11 is used for generating a sensed signal associated with the neighboring area thereof and judging whether the received sensed signal meets a criterion or not. If the received sensed signal meets the criterion, the sensor generates a trigger signal. The aforesaid function can be achieved by a preinstalled application programming interface (API).

The transmitting module 12 is electrically coupled to the sensor 11. The transmitting module 12 is used for transmitting the trigger signal in a wireless local communication protocol. The wireless local communication protocol is an IEEE 802.15.4 standard, for example.

The coordinator 20 comprises a receiving module 21, a storage device 22, a communication module 23, and a processor 24. The coordinator 20 can be provided with a platform conforming to an open service gateway initiative (OSGi) specification, and it integrates a universal plug and play (UPnP) standard, such that different sensing units 10 can easily communicate with the coordinator 20.

The receiving module 21 is used for receiving the trigger signal transmitted by one of the M transmitting modules 12.

The storage device 22 is used for storing I contact rules. I is a natural number. Each of the I contact rules corresponds to one of the M transmitting modules 12 and at least one of the N terminals 40.

In an embodiment, the coordinator 20 further comprises an editing module. The editing module is electrically connected to the storage device 22. The editing module is used for editing the I contact rules stored in the storage device 22.

The communication module 23 is capable of linking to the external communication network 30. The processor 24 is electrically connected to the receiving module 21, the storage device 22, and the communication module 23, respectively.

The processor 24 is used for receiving the trigger signal received by the receiving module 21 and transmitted by the transmitting module 12. The processor 24 accesses the contact rules corresponding to the transmitting module 12 from the storage device 22, and transmits, according to the accessed contact rule, information to the terminals 40 corresponding to the accessed contact rule through the communication module 23 and the external communication network 30.

In practical application, a house is configured with a home security system of the invention capable of linking to an external communication network. The home security system comprises a sensing unit and a coordinator. The sensing unit is a smoke detector, for example.

The smoke detector comprises a sensor and a transmitting module. The sensor is used for sensing the concentration of smoke particles. An API is used for judging whether the concentration of smoke particles meets the criterion, if YES, a trigger signal is generated. The transmitting module transmits the trigger signal in the IEEE 802.15.4 wireless local communication protocol.

When a fire accident occurs in the house, the smoke detector transmits a trigger signal to the coordinator. The coordinator is provided with an open platform conforming to the OSGi specification, and it integrates the UPnP standard, such that different sensing units can easily communicate with the coordinator.

The receiving module of the coordinator receives the trigger signal transmitted by the smoke detector.

The processor of the coordinator receives the trigger signal received by the receiving module and transmitted by the smoke detector. The processor accesses the contact rule corresponding to the smoke detector from the storage device of the coordinator. For example, the contact rule can be set as follows, when the smoke detector transmits a trigger signal, the fire station and the members of the family are notified through a wireless telecommunication system network.

According to the accessed contact rule, the processor of the coordinator notifies the fire station and members of the family through the wireless telecommunication system network. The fire station can dispatch fire engines to put out fire, and the members of the family can immediately receive the message of fire accident.

Obviously, the invention provides a home security system capable of linking to an external communication network, and the sensing unit of the home security system transmits the trigger signal in the IEEE 802.15.4 wireless local communication protocol (Zigbee wireless communication). Therefore, the home security system of the invention has advantages in low cost and power-saving. Additionally, the coordinator of the home security system can be preset with at least one contact rule. According to the contact rule corresponding to the sensing unit generating the trigger signal, the coordinator transmits information to the terminals corresponding to the contact rule via the external communication network.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A home security system capable of linking to an external communication network, N terminals being capable of linking to the external communication network, N being a natural number, said home security system comprising:
M sensing units, each of the M sensing units comprising:
a sensor for generating a sensed signal associated with the neighboring area thereof and judging whether the sensed signal meets a criterion, and if the sensed signal meets the criterion, the sensor generating a trigger signal; and
a transmitting module, electrically connected to the sensor, for transmitting the trigger signal in a wireless local communication protocol; and
a coordinator comprising:
a receiving module for receiving the trigger signal from one of the M transmitting modules;
a storage device for storing I contact rules, each corresponding to one of the M transmitting modules and at least one of the N terminals;
a communication module capable of linking to the external communication network; and
a processor, electrically connected to the receiving module, the storage device, and the communication module, respectively, for receiving the trigger signal from the receiving module, accessing the contact rule corresponding to the transmitting module from the storage device, and transmitting, according to the accessed contact rule, information to the terminals corresponding to the accessed contact rule through the communication module and the external communication network; wherein N, M and I are natural numbers.

2. The home security system of claim 1, wherein the wireless local communication protocol is an IEEE 802.15.4 standard.

3. The home security system of claim 1, wherein the coordinator also comprises an editing module, electrically connected to the storage device, for editing the contact rules stored in the storage device.

4. The home security system of claim 1, wherein the external communication network is one selected from the group consisting of a radio telecommunication system network, a wireless wide area network, and an internet.
